(19) United States
(12) Patent Application Publication
(10) Pub. No.: US 2002/0114870 A1
(43) Pub. Date: Aug. 22, 2002

(54) Portable, stacked container and method for separately storing and dispensing two consumable products, especially cereal and milk

(76) Inventors: John P. Rebhorn, Maple Grove, MN (US); Mayank T. Patel, Maple Grove, MN (US); Peter C. Erickson, Plymouth, MN (US)

Correspondence Address: DICKE, BILLIG & CZAJA, Suite 1250, 701 Building, 701 Fourth Avenue South, Minneapolis, MN, 55415, US

(21) Appl. No.: 09/781,581

(22) Filed: Feb. 12, 2001

(51) Int. Cl. A23B 4/00

(52) U.S. Cl. 426/120

(57) ABSTRACT

A portable, single-use container for separately containing a dry consumable product and a liquid consumable product. The container includes a first, outer compartment; a second, inner compartment; and a cover. The first compartment includes a bottom, a first compartment side wall and an annular rim. The first compartment side wall extends from the bottom and defines a first compartment internal storage region. The annular rim is formed at a top of the first compartment side wall. The second compartment similarly includes a base, a second compartment side wall, and an annular lip. The second compartment side wall extends from the base and defines a second compartment internal storage region. The annular lip is formed at the top of a second compartment side wall, defining a dry product opening and forming a pour opening. The dry product opening provides access to the internal storage region. The pour opening is positioned along the annular lip so as to be offset from the dry product opening. Finally, the cover is secured to the lip, encompassing both the dry product opening and the pour opening. Upon final assembly, the second compartment nests within the first compartment such that the lip abuts the rim. Further, a fluid passageway is established between an interior surface of the first compartment side wall and an exterior surface of the second compartment side wall. The fluid passageway fluidly connects the first compartment internal storage region and the pour opening. During use, a liquid consumable product, otherwise disposed within the first compartment, can be dispensed through the pour opening substantially concurrently with dispensement of a dry consumable product from the dry product opening.

### BACKGROUND OF THE INVENTION

The present invention relates to a unitary container that separately contains two consumable products. More particularly, it relates to a portable, single-use container that preferably contains both a dry product and a liquid product, such as milk and cereal, and promotes single-handed, simultaneous dispensing of the products.

A highly popular combination food item is dry cereal and milk. Typically, the cereal and milk are combined in a bowl, and then consumed using a spoon. Thus, so long as the consumer is at a stationary location and has a table and spoon available, the cereal and milk meal is readily prepared and eaten. Unfortunately, however, it is virtually impossible to easily consume the milk and cereal while traveling (or “on-the-go”) due to the open nature of the bowl and the requirement of a spoon. For example, it is highly difficult to carry a bowl of cereal and milk without spilling the combination product (e.g., walking, hiking, traveling in an automobile, etc.). Further, on-the-go consumption (i.e., no convenient structure such as a table onto which the bowl can be placed) occupies both of the user's hands; one hand holding the bowl and the other hand holding the spoon.

This lack of transportability is in direct contrast to recent consumer preferences. In particular, consumers have expressed a heightened desire for their favorite consumable products to be packaged in single-serving containers that facilitate convenient, single-handed, on-the-go consumption. In fact, manufacturers have now made available a wide variety of food products in portable, single-handed consumption packages or containers. For example, beverages, such as soda pop, milk, etc., are commonly sold in single-serving containers. Similarly, other food products, ranging from yogurt to dry snack foods, are also similarly packaged. In general terms, the packaging technique for these products is relatively straightforward in that only a single type of consumable item is contained. In other words, a single-serving beverage container need only define a single storage region for containing the beverage. Similarly, a snack food package has a single compartment enclosing a single type of snack food. In direct contrast, a container for cereal and milk must separately contain the two items prior to consumption. If the cereal and milk were combined within a single compartment, the quality of the cereal would quickly deteriorate, as would the milk.

Efforts have been made to provide packaging that separately contains a single-serving of cereal and a single-serving of milk. For the most part, however, these packaging efforts still require a spoon for consumption of the combined cereal and milk, and thus do not promote on-the-go consumption. Alternatively, a hand-held container defining a first compartment for milk and a second compartment for cereal has been proposed, for example, by Ness, U.S. Pat. No. 5,753,289 and Dickerson, U.S. Pat. No. 5,706,980. While satisfying several consumer preferences, the available single container, dual compartment designs raise additional potential drawbacks. As a starting point, to be viable on a mass production basis, the milk compartment must be sanitized prior to filling with milk, to provide an extended shelf life or ultra-pasteurized product for sale to consumers. With this in mind, the container of U.S. Pat. No. 5,753,289 utilizes a single screw cap to close integrally formed cereal and milk compartments. Unfortunately, because both compartments are fully exposed when the cap is removed, it is virtually impossible for the product manufacturer to sterilize the container, fill the compartments with cereal and milk in an appropriately sterilized environment, and then seal the container without negatively impacting the quality of the milk and/or cereal. In other words, if the milk is dispensed before the cereal is placed within cereal compartment, the subsequent cereal dispensement will destroy the requisite sterility of the milk compartment. Conversely, if the cereal compartment is filled first and then the milk compartment sanitized, the sanitizing agent will likely contact the cereal, rendering it inedible.

Dickerson, U.S. Pat. No. 5,706,980 presents similar concerns in that the milk compartment is never completely sealed. Thus, the resulting product has an inherently limited shelf life, and is not conducive to appropriate sterilization. Further, a top surface of the package is angularly oriented relative to a bottom surface, so that it is exceedingly difficult to stack multiple packages on top of one another such as, for example, within a single shipping crate as is typically required for cost effective delivery to a retailer. Also, the container is specifically designed to be re-usable. Unfortunately, most consumers do not appreciate the level of cleanliness required of a milk container and are therefore unlikely to properly sanitize at least the milk compartment between uses.

An untapped consumer demand exists for a single-serving, combination cereal and milk packaged good item. Unfortunately, existing designs either hinder on-the-go consumption, or present potentially insurmountable manufacturing obstacles. Therefore, a need exists for a portable, single-use packaged good item that separately contains both a dry consumable product, such as cereal and a liquid consumable product, such as milk, and a method of manufacturing such an item.

### SUMMARY OF THE INVENTION

One aspect of the present invention relates to a portable, single-use container for separately containing two consumable products. The container includes a first, outer compartment; a second, inner compartment; and a cover. The first compartment includes a bottom, a first compartment side wall and an annular rim. The first compartment side wall extends from the bottom and defines a first compartment internal storage region. The annular rim is formed at a top of the first compartment side wall. The second compartment similarly includes a base, a second compartment side wall, and an annular lip. The second compartment side wall extends from the base and defines a second compartment internal storage region. The annular lip is formed at the top of a second compartment side wall, defining a dry product opening and forming a pour opening. The dry product opening provides access to the internal storage region. The pour opening is positioned along the annular lip so as to be offset from the dry product opening and the second compartment internal storage region. Finally, the cover is secured to the lip, encompassing both the dry product opening and the pour opening. Upon final assembly, the second compartment nests within the first compartment such that the lip abuts the rim. A fluid passageway is established between an interior surface of the first compartment side wall and an exterior surface of the second compartment side wall. The fluid passageway fluidly connects the first compartment internal storage region and the pour opening. In one preferred embodiment, a portion of the cover is selectively removable from the lip of the second compartment, thereby exposing both the pour opening and a portion of the dry product opening. During use, a consumable product, preferably a liquid consumable product, otherwise disposed within the first compartment, can be dispensed through the pour opening substantially concurrently with dispensement of a second consumable product from the dry product opening.

Yet another aspect of the present invention relates to a portable, single-use container for separately containing two consumable products. The container includes a first, outer compartment; a second, inner compartment; and a cover. The first compartment includes a bottom, a first compartment side wall and an annular rim. The first compartment side wall extends from the bottom and defines a first compartment internal storage region. The annular rim is formed at a top of the first compartment side wall. The second compartment similarly includes a base, a second compartment side wall, and an annular lip. The second compartment side wall extends from the base and defines a second compartment internal storage region. The annular lip is formed at the top of a second compartment side wall, defining a dry product opening and forming a pour opening. The dry product opening provides access to the internal storage region. The pour opening is positioned along the annular lip so as to be offset from the dry product opening and the second compartment internal storage region. Finally, the cover is secured to the lip, encompassing both the dry product opening and the pour opening. Upon final assembly, the second compartment nests within the first compartment and the lip is attached to the rim, preferably via an ultrasonic weld. A fluid passageway is established between an interior surface of the first compartment side wall and an exterior surface of the second compartment side wall. The fluid passageway fluidly connects the first compartment internal storage region and the pour opening.

Yet another aspect of the present invention relates to a portable, single-use container for separately containing two consumable products. The container includes a first, outer compartment; a second, inner compartment; and a cover. The first compartment includes a bottom, a first compartment side wall and an annular rim. The first compartment side wall extends from the bottom and defines a first compartment internal storage region. The annular rim is formed at a top of the first compartment side wall. The second compartment similarly includes a base, a second compartment side wall, and an annular lip. The second compartment side wall extends from the base and defines a second compartment internal storage region. The annular lip is formed at the top of a second compartment side wall, defining a dry product opening and forming a pour opening. The dry product opening provides access to the internal storage region. The pour opening is positioned along the annular lip so as to be offset from the dry product opening and the second compartment internal storage region. Upon final assembly, the second compartment nests within the first compartment, establishing a fluid passageway between the first compartment internal storage region and the pour opening. The cover is secured to the lip, and at least the first compartment internal storage region is entirely sealed. During use, a consumable product, preferably a liquid consumable product is storable within the sealed, internal storage region of the first compartment for extended periods of time without experiencing environmental contamination.

Yet another aspect of the present invention relates to a portable, single-use container for separately containing two consumable products. The container includes a first, outer compartment; a second, inner compartment; and a cover. The first compartment includes a bottom, a first compartment side wall and an annular rim. The first compartment side wall extends from the bottom and defines a first compartment internal storage region. The annular rim is formed at a top of the first compartment side wall. The second compartment similarly includes a base, a second compartment side wall, and an annular lip. The second compartment side wall extends from the base and defines a second compartment internal storage region. The annular lip is formed at the top of a second compartment side wall, defining a dry product opening and forming a pour opening. The dry product opening provides access to the internal storage region. The pour opening is positioned along the annular lip so as to be offset from the dry product opening and the second compartment internal storage region. Finally, the cover is secured to the lip, encompassing both the dry product opening and the pour opening. Upon final assembly, the second compartment nests within the first compartment such that a plane defined by a top surface of the lip is parallel with a lower surface of the first compartment bottom. With this configuration, a second, similarly formed container is readily stackable on top of the container for subsequent shipment to a retailer. Regardless, a fluid passageway is established between an interior of the first compartment and an exterior of the second compartment, fluidly connecting the first compartment internal storage region with the pour opening.

Yet another aspect of the present invention relates to a packaged good article including a portable, single-use container, a first consumable product, and a second liquid consumable. The container includes a first, outer compartment; a second, inner compartment; and a cover. The first compartment includes a bottom, a first compartment side wall, and an annular rim. The first compartment side wall extends from the bottom and defines an internal storage region. The annular rim is formed at a top of the first compartment side wall. Similarly, the second compartment includes a base, a second compartment side wall, and an annular lip. The second compartment side wall extends from the base and defines a second compartment internal storage region. The annular lip is formed at a top of the second compartment side wall, defining a dry product opening and forming a pour opening. The dry product opening provides access to the second compartment internal storage region. The pour opening is offset from the dry product opening and the second compartment internal storage region. Finally, the cover is secured to the lip. The second consumable product is contained within the second compartment internal storage region, whereas the first consumable product is sealed within the first compartment internal storage region. In one preferred embodiment, the second consumable product is approximately ¾ cup of RTE cereal, whereas the first consumable product is approximately 4 fluid ounces of milk. During use, a portion of the milk and a portion of the cereal can be concurrently dispensed from the pour opening and the dry product opening.

Yet another aspect of the present invention relates to a method of manufacturing a portable, single-use container that separately contains two consumable products. The method includes providing a first, outer compartment including a bottom, a first compartment side wall, and an annular rim. A second, inner compartment is also provided that includes a base, a second compartment side wall, and an annular lip. The annular lip forms a pour opening. The second consumable product is dispensed into the second compartment. The first consumable product is dispensed into the first compartment. The second compartment is placed into the first compartment such that the lip abuts the rim. Finally, the lip is sealed to the rim. With this configuration, a fluid passageway is established between an exterior surface of the second compartment side wall and an interior surface of the first compartment side wall for allowing passage of the first consumable product from the first compartment to the pour opening.

In one preferred embodiment, the method further comprises covering the second compartment, including the pour opening, after dispensing the second consumable product. The exterior surface of the second compartment is then sterilized, preferably aseptically sterilized. Similarly, the first compartment is sterilized, preferably aseptically sterilized. Following sterilization, the first consumable product is dispensed into the first compartment and the second compartment is placed into the first compartment. By this methodology, upon final assembly, the first consumable product is contained within a sanitized environment whereby all surfaces otherwise in contact with the first consumable product, including the interior surface of the first compartment and the exterior surface of the second compartment, have been sanitized just prior to filling the first compartment with first consumable product.

In another embodiment, the method of manufacture further comprises first sealing the pour opening formed by the second compartment prior to placing the second compartment into the first compartment. Then, both the first and second compartments are sanitized. The first consumable product is then dispensed into the first compartment, and the second compartment is placed into the first compartment. Finally, the second consumable product is dispensed into the second compartment only after placing the second compartment into the first compartment and sealing the lip to the rim. With this methodology, upon final assembly, the first consumable product is contained within a sanitized environment.

Yet another aspect of the present invention relates to a method for dispensing two consumable products from a portable, single-use container. The method includes providing a container including a first, outer compartment containing a liquid consumable product, a second, inner compartment containing a dry consumable product, and a cover that covers the second compartment. The second compartment includes an annular lip forming a pour opening and is nested within the first compartment such that the lip is secured to an annular rim of the first compartment and a fluid passageway to the pour opening is established by an interior surface of the first compartment and an exterior surface of the second compartment. At least a portion of the cover is removed to expose the pour opening and at least a portion of the second compartment. The container is then grasped by a consumer, preferably with a single hand. Finally, a portion of the first consumable product and a portion of the second consumable product are substantially simultaneously dispensed through the pour opening and from the second compartment, respectively. In one preferred embodiment, the consumable products are dispensed in close proximity to one another.

### BRIEF DESCRIPTION OF THE DRAWINGS

FIG. 1 is an exploded, perspective view of a container in accordance with the present invention;

FIG. 2A is a front view of an outer compartment of the container of FIG. 1;

FIG. 2B is a top view of the compartment of FIG. 2A;

FIG. 3A is a front view of an inner compartment of the container of FIG. 1;

FIG. 3B is a top view of the compartment of FIG. 3A;

FIG. 4 is a cross-sectional view of the container of FIG. 1 in an assembled state;

FIG. 5 is a flow diagram illustrating one method of manufacture in accordance with the present invention;

FIGS. 6A-6C illustrate manufacture of a container in accordance with the method of FIG. 5;

FIG. 7 is a flow diagram illustrating an alternative method of manufacture in accordance with the present invention;

FIG. 8A-8C illustrate a method of manufacturing a container in accordance with FIG. 7; and

FIG. 9 is a cross-sectional view of a packaged good article in accordance with the present invention during use.

### DESCRIPTION OF THE PREFERRED EMBODIMENTS

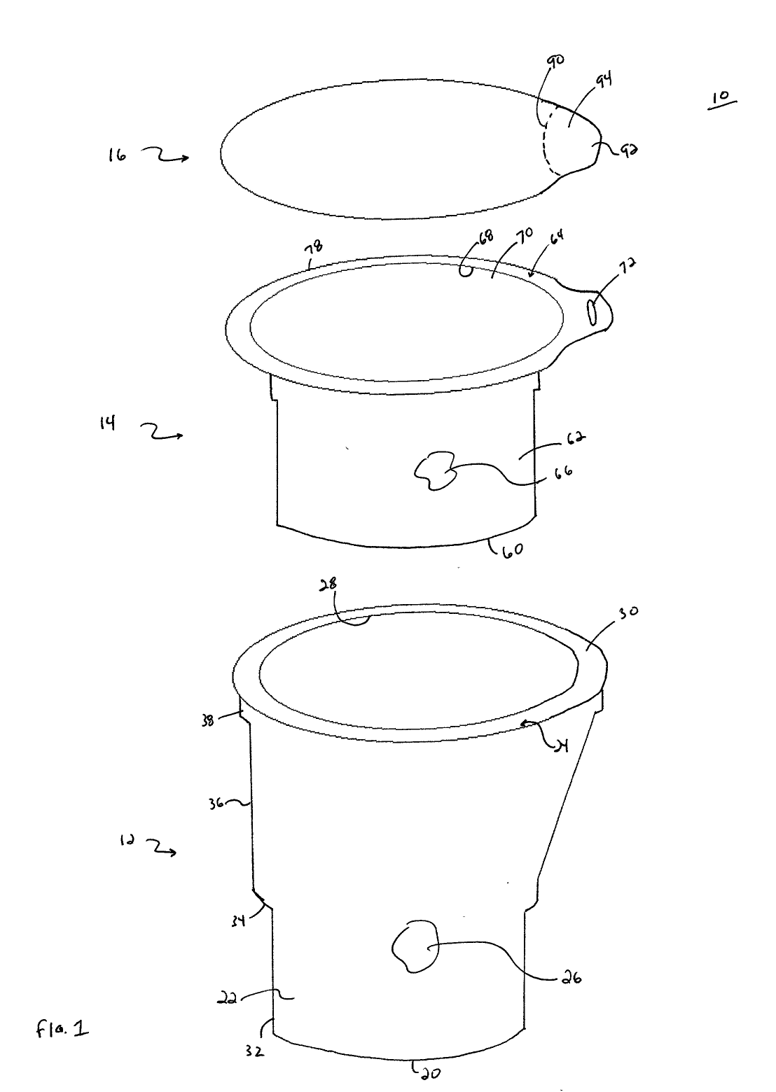

One embodiment of a container 10 in accordance with the present invention is provided in FIG. 1. The container 10 includes a first, outer compartment 12, a second, inner compartment 14, and a cover 16. Details on the various components are described below. In general terms, however, the container 10 utilizes a “cup-within-a-cup” design, whereby the second compartment 14 nests within the first compartment 12. The cover 16 covers the second compartment 14. With this configuration and in one preferred embodiment, a dry consumable product, such as cereal, (not shown) can be contained within the second compartment 14, and a liquid consumable product, such as milk, (not shown) can be contained within the first compartment 12. Upon removal of at least a portion of the cover 16, the consumable products can be substantially simultaneously dispensed from the container 10.

The first compartment 12 includes a bottom 20, a side wall 22 and an annular rim 24. The side wall 22 extends from the bottom 20 to define an internal storage region 26. The annular rim 24 extends radially outwardly from a top 28 of the side wall 22. As described in greater detail below, the annular rim 24 forms an upper surface 30 configured to receive a portion of the second compartment 14. Notably, directional terminology, such as “upper,” “lower,” “top,” and “bottom” are used for purposes of illustration only and with reference to a desired upright orientation of the container 10 as shown in FIG. 1. However, the container 10 can be positioned in other orientations such that the directional terminology is in no way limiting.

The first compartment 12 is preferably configured to promote containment of a single-serving volume of liquid consumable product (not shown), temporary storage in a cup holder (not shown), single-handed use, and acceptable liquid flow rate. With this in mind, the bottom 20 is preferably circular in transverse cross-section, and the side wall 22 defines a lower section 32, a neck 34, an upper section 36 and shoulder 33. The lower section 32 extends upwardly from the bottom 20. The neck 34 extends between the lower section 32 and the upper section 36. Finally, the shoulder 38 extends from the upper section 36 and terminates at the rim 24.

The lower section 32 and the bottom 20 are preferably sized for placement within most available cup holders (not shown) typically found in automobiles, sport stadiums, theaters, etc. Thus, in a preferred embodiment, the bottom 20 has a diameter in the range of 2-3 inches, most preferably approximately 2.2 inches (±0.2 inch). The lower section 32 approximately maintains this same transverse diameter, although expanding slightly radially outwardly to the neck 34, preferably forming an included angle of approximately 4.5°. Alternatively, the lower section 32 can be vertical or can exhibit a more discernable radial expansion. Regardless, in one preferred embodiment, the lower section 32 has a height of approximately 1.73 inches (±0.1 inch), so that the internal storage region 26 along the lower section 32 is sufficiently sized to contain a single serving volume of liquid consumable product (e.g., 4 fluid ounces) while fitting within most available cupholders.

The neck 34 extends from the lower section 32, defining a relatively large radial expansion as the side wall 22 transitions from the lower section 32 to the upper section 36. In one preferred embodiment, the neck 34 expands radially outwardly at an angle of approximately 60° (relative to horizontal), and has a linear height of approximately 0.25 inch (±0.05 inch). Other dimensions or configurations for the neck 34 are also acceptable.

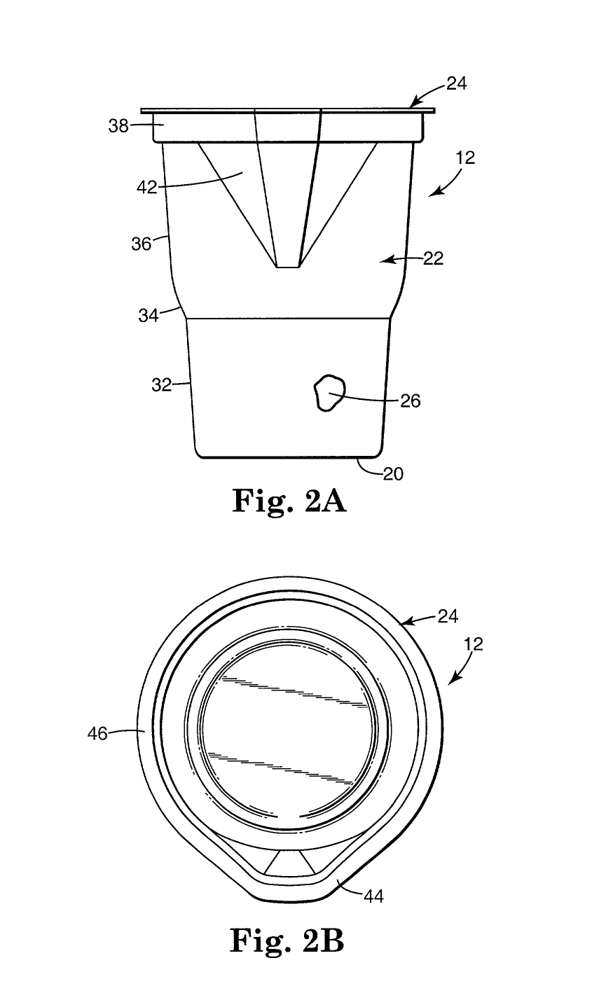

The upper section 36 extends from the neck 34, and, in conjunction with the shoulder 38, preferably forms a spout 42, as best shown in FIG. 2A. thus, in a preferred embodiment, the upper section 36 is circular in transverse cross-section except in the region of the spout 42, where a more radical radial expansion is defined. The upper section 36 is further sized in accordance with the second compartment 14 (FIG. 1), preferably having a height of approximately 1.85 inches (±0.1 inch), although other dimensions are also acceptable. Similarly, the shoulder 38 is sized in accordance with the second compartment 14, preferably having a height of approximately 0.40 inch (±0.1 inch). Taken in combination, the upper section 36 and the shoulder 38 are sized to retain the second compartment 14 above the lower section 32. To promote grasping of the first compartment 12 with a single hand, the upper section 36 preferably has a diameter of approximately 3 inches (±0.2 inch).

With additional reference to FIG. 2B, the rim 24 corresponds in transverse shape with the side wall 22, preferably defining a mouth portion 44 and a trailing portion 46 (referenced generally in FIG. 2B). The mouth 44 corresponds with the spout 42 (FIG. 2A), and thus extends to a radius greater than that defined by the trailing portion 46. By way of example, in one preferred embodiment, the trailing portion 46 has a radius of approximately 1.75 inch, whereas the mouth 44 extends to a radius of approximately 2 inches.

Regardless, the rim 24 preferably has a uniform transverse or radial width, sufficiently sized to receive a corresponding portion of the second compartment 14 (FIG. 1). To this end, it has surprisingly been found that forming the rim 24 to a radial width of approximately 0.125 inch (±0.05 inch) provides sufficient surface area for affixing the second compartment 14, while minimizing complications during use.

The first compartment 12 preferably has a height, and thus a resulting volume of the internal storage region 26, sufficient to contain both the second compartment 14 and a desired volume of a liquid food product (not shown) (e.g., 4 fluid ounces). Conversely, however, a height of the first compartment 12 is preferably as small as possible so as to maximize overall stability of the container 10. With these parameters in mind, the first compartment 12 preferably has a height in the range of 4-5 inches, more preferably 4.3 inches, which surprisingly provides a sufficient volume for the internal storage region 26 while maintaining overall stability.

The first compartment 12, including the bottom 20, the side wall 22, and the annular rim 24, is preferably integrally formed from a plastic material. Because the first compartment 12 is in direct contact with a consumable item, a material approved for food contact should be employed, as is well known in the art. Further, the skilled artisan will appreciate that in other variations, the first compartment 12 can be fabricated such that the bottom 20, the side wall 22 and/or the annular rim 24 are separately formed and subsequently assembled. Preferably, however, the first compartment 12 is thermoformed from a flat sheet. Alternatively, plastic injection or blow molding techniques can be employed. Finally, the first compartment 12, and in particular the side wall 22, is preferably relatively thin and therefore resilient, so that a consumer (not shown) can easily “squeeze” the first compartment 12 to temporarily reduce a volume of the internal storage region 26 for reasons made clear below.

Returning to FIG. 1, the second compartment 14 includes a base 60, a side wall 62, and an annular lip 64. The side wall 62 extends from the base 60 and defines an internal storage region 66. The lip 64 extends radially outwardly from a top 68 of the side wall 62. The lip 64 defines a dry product opening 70 and forms a pour opening 72. The dry product opening 70 provides access to the internal storage region 66, whereas the pour opening 72 is offset therefrom, as described in detail below.

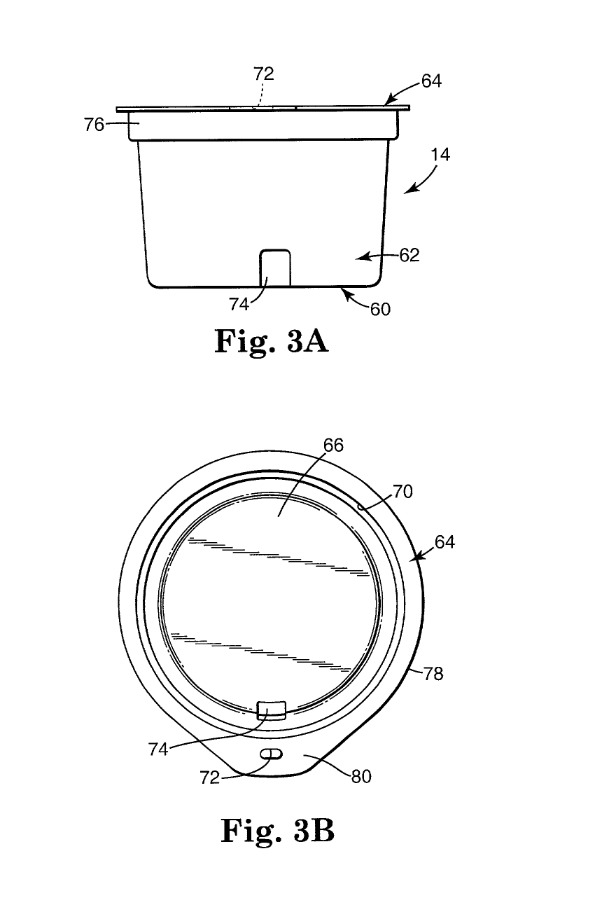

The second compartment 14 is sized for placement or nesting within the first compartment 12, with the lip 64 abutting the rim 24. Thus, the base 60 and the side wall 62 of the second compartment 14 define transverse dimensions, as well as a height, smaller than that of the first compartment 12. In this regard, the side wall 62 is preferably generally cylindrical in shape, corresponding generally with a shape or taper of the side wall 22 of the first compartment 12. Preferably, however, the side wall 62 does not incorporate a feature corresponding with the spout 42 of the first compartment 12 (FIG. 2A). That is to say, the side wall 62 is preferably circular in transverse cross-section. In one preferred embodiment, and as shown in FIG. 3A, a recess 74 is formed at a lower portion of the side wall 62 opposite the pour opening 72 (FIG. 1). The recess 74 facilitates fluid flow about the second compartment 14 upon final assembly, as described in greater detail below.

The side wall 62 preferably forms a shoulder 76 at an upper portion thereof. The shoulder 76 is sized and configured in accordance with the shoulder 38 (FIG. 2A) of the first compartment 12 to facilitate the desired nesting relationship upon final assembly. With this in mind, and in accordance with the one preferred embodiment, the shoulder 76 has a height of approximately 0.45 inch (±0.1 inch).

With additional reference to FIG. 3B, the lip 64 corresponds generally in transverse shape and dimensions with the rim 24 (FIG. 2B). In particular, an outer perimeter 78 of the lip 64 is substantially identical to the rim 24. Further, the lip 64 forms a radial extension 80, corresponding with the mouth 44 (FIG. 2B) of the rim 24. The radial extension 80 defines a radial or transverse width greater than a remainder of the lip 64. For example, in one preferred embodiment, the radial extension 80 has a width of approximately 0.25 inch, whereas a remainder of the lip 64 has a width of approximately 0.125 inch. With this preferred configuration, the radial extension 80 provides sufficient surface area to form the pour opening 72 at a position offset or fluidly separated from the dry product opening 70, and thus the internal storage region 66, along with providing sufficient surface area for engaging the rim 24 upon final assembly.

The pour opening 72 is sized to allow passage of a liquid consumable product (not shown) therethrough. In one preferred embodiment, and as shown in FIG. 3B, the pour opening 72 is an elongated semi-circle. It has surprisingly been found that forming the pour opening 72 to have a major diameter of approximately 0.25 inch (±0.01 inch) and a minor diameter of approximately 0.125 inch (±0.01 inch) facilitates an acceptable flow rate of a liquid consumable product (not shown) during use, while requiring minimal space. Alternatively, a variety of other shapes and dimensions can be employed, including oval, rectangular, etc. Even further, the pour opening 72 need not necessarily be elongated.

Similar to the first compartment 12, the second compartment 14, including the base 60, the side wall 62, and the lip 64, is preferably integrally formed from a plastic material. Because the second compartment 14 is in direct contact with food, a material approved for food contact should be employed, as is well known in the art. Alternatively, the base 60, the side wall 62, and the lip 64 can be separately formed and subsequently assembled. In one preferred embodiment, the second compartment 14 is thermoformed from a flat sheet. Alternatively, plastic injection or blow molding techniques can be employed.

Returning to FIG. 1, the cover 16 provides a sanitary seal for consumable products (not shown) otherwise contained within the first and second compartments 12, 14. In one preferred embodiment, the cover 16 includes a single sheet of thin film-type material that is sealable to the lip 64 of the second compartment 14. Thus, the cover 16 is preferably shaped in accordance with the perimeter 78 of the lip 64, and is sized to cover an entirety of a top of the second compartment 14, including the dry product opening 70 and the pour opening 72. Notably, by forming the lip 64 to preferably have a minimum radial width of approximately 0.125 inch, sufficient surface area is provided along a top surface 82 of the lip 64 for receiving the cover 16. While a wide variety of film materials can be used for the cover 16, the material selected preferably is approved for contact with food and provides a contaminant barrier. In one preferred embodiment, the cover 16 is metalized film or foil as known in the art. Alternatively, the cover 16 is formed from a polymer such as polyethylene, polypropylene, PET, polystyrene, etc. Additionally, the cover 16 may include indicia (not shown), such as a manufacturer trademark or trade name, product description, instructions for use, etc.

As described in greater detail below, upon final assembly, at least a portion of the cover 16 can be removed from the lip 64 to expose the pour opening 72 and at least a portion of the dry product opening 70. As such, in one preferred embodiment, a tear line 90 and a tab 92 are formed in the cover 16, as shown in FIG. 1. The tear line 90 facilitates removal or peeling back of a small section 94 (contiguous with the tab 92) from a remainder of the cover 16 by a user (not shown). The tab 92 further promotes detachment from the lip 64 by providing a conveniently graspable surface. A number of different techniques, such as partial cuts, perforations, etc., are available for effectuating the tear line 90, and the tear line 90 can assume a variety of shapes other than that illustrated in FIG. 1. Alternatively, access to the pour opening 72 and the dry product opening 70 can be afforded by removing the cover 16 entirely, such that the tear line 90 is not a required element. Even further, the tear line 90 can instead be a fold line such that the tab 92 is pivoted (along the fold line) away from the openings 70, 72). Similarly, the cover 16, or a portion thereof, can be removed from the lip 64 without requiring the tab 92.

While the cover 16 has been described as preferably comprising a single film material adhered or otherwise bonded to the lip 64, other configurations are equally acceptable. For example, the cover 16 can be a relatively thick sheet of plastic material that is snap fitted to the second compartment 14. Alternatively, and as described in greater detail below, the cover 16 can include a plurality of components, including, for example, two film pieces for separately covering the pour opening 72 and the dry product opening 70.

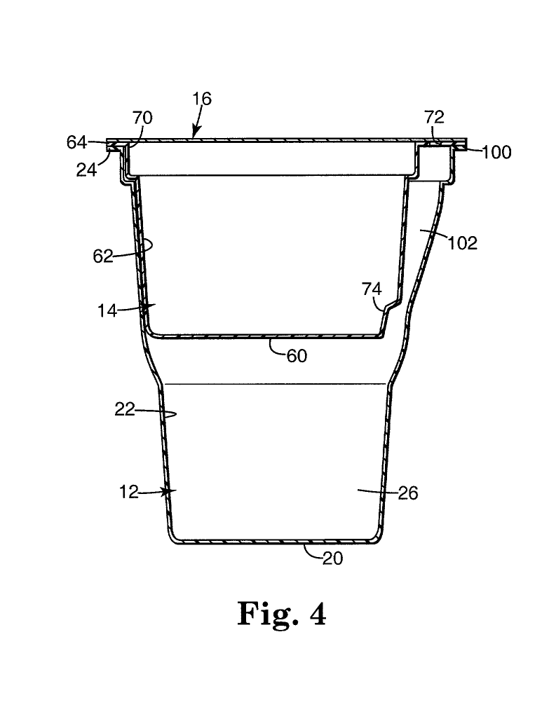

The container 10 is illustrated in a final, assembled state in FIG. 4. For ease of illustration, the container 10 is depicted without contained consumable products. The cover 16 is secured to the lip 64 of the second compartment 14, encompassing both the dry product opening 70 and the pour opening 72. The second compartment 14, in turn, is nested within the first compartment 12, such that the lip 64 abuts the rim 24. More particularly, the lip 64 rests on top of the rim 24. This preferred configuration allows the first compartment 12 to fully support the second compartment 14 so that the first compartment 12 will not unexpectedly “tilt” relative to the second compartment 14. Further, because the lip 64 and the rim 24 have corresponding radial widths (preferably approximately 0.125 inch), sufficient surface area is provided for permanently affixing the two compartments 12, 14. In fact, in a preferred embodiment, the lip 64 is permanently secured to the rim 24, for example with an ultrasonic weld 100. Alternatively, other attachment techniques, such as adhesive, mechanical fasteners, snap-fit, etc., can be utilized. Regardless, because the compartments 12, 14 are preferably sealably affixed to one another and the pour opening 72 is sealed by the cover 16, the internal storage region 26 of the first compartment 12 can be completely sealed.

The compartments 12, 14 are configured such that in the assembled state, the second compartment 14 occupies less than an entirety of the internal storage region 26 of the first compartment 12, to allow containment of a consumable product (not shown) within the first compartment 12. For example, the second compartment 14 has a height less than that of the first compartment 12, establishing a spacing between the base 60 and the bottom 20 sufficient for containing the liquid consumable product. Further, a spacing is generated between the side walls 22, 62. In particular, a fluid passageway 102 is formed between an interior of the first compartment side wall 22 and an exterior of the second compartment side wall 62. The fluid passageway 102 is most prominently defined in the region of the recess 74 otherwise formed by the second compartment side wall 62. Regardless, the fluid passageway 102 fluidly connects the pour opening 72 with that portion of the internal storage region 26 of the first compartment 12 not otherwise occupied by the second compartment 14. With this configuration, upon removal of at least a portion of the cover 16, a liquid consumable product (not shown) can readily be dispensed from the first compartment internal storage region 26 via the fluid passageway 102 and the pour opening 72.

An additional preferred feature of the container 10 upon final assembly is that an upper plane (as defined by the cover 16 otherwise affixed to the lip 64) and a lower plane (as otherwise defined by the bottom 20 of the first compartment 12) are substantially parallel to one another (i.e., within 5° of a true parallel relationship). In other words, when placed on a flat, horizontal surface, the upper and lower most planes of the container 10 are both substantially horizontal. As a result, a second container (not shown) is readily stackable on top of the container 10, so that a plurality of similar containers are conveniently placed within a relatively small shipping space. This highly desirable attribute would be unavailable were the upper plane angularly oriented relative to the lower plane.

The container 10 can assume a wide variety of other shapes and dimensions apart from the one preferred embodiment described above. The resulting configuration, however, provides at least one of the following preferred characteristics: the lip 64 abutting the rim 24, the second compartment 13 being permanently affixed to the first compartment 12, the internal storage region 26 of the first compartment 12 being completely sealed, or the upper and lower most planes of the container 10 being substantially parallel. In a most preferred embodiment, the container configuration provides all of these features.

Regardless of the exact configuration, the method of manufacturing the resulting container 10, including separately containing two consumable products, entails the same general steps. As a point of reference, the following description of the method of manufacturing describes a liquid consumable product as being contained by the first compartment 12, and a dry consumable product as being contained by the second compartment 14. Alternatively, the compartments may both contain a dry consumable product or a liquid consumable product, or the liquid consumable product may be contained by the second compartment 14 and a consumable product may be contained by the first compartment 12. With respect to the most preferred embodiment, because the liquid consumable product contained by the container 10 is preferably milk, specific cleanliness standards must be adhered to. In particular, regulations relating to handling of milk require that for a milk container to qualify as “shelf-stable” for shipping purposes, the milk container must be first aseptically sterilized, for example with hydrogen peroxide. Once the container is sterilized, the milk must be dispensed into the container, and the container sealed, in a sterilized environment. Similarly, to qualify as an “extended shelf life” or ultra-pasteurized” product, the milk container must be sterilized, filled, and sealed in a sterile environment. Thus, with specific reference to the embodiment of FIG. 1, the first compartment 12 must be sterilized, preferably aseptically sterilized, prior to filling with milk (or other liquid consumable product having container sterilization requirements). Further, because an exterior of the second compartment 14 will also come into contact with the milk, the second compartment 14, or at least an exterior thereof, must also be sterilized, preferably aseptically sterilized, prior to assembly to the first compartment 12. In this regard, every effort must be made to avoid contaminating a dry consumable product otherwise contained within the second compartment 14 with the sterilizing agent. Finally, the pour opening 70 must be covered (such as with the cover 16) shortly after, preferably before, nesting the second compartment 14 within the first compartment 12, so as to seal the milk within the first compartment 12. With these constraints in mind, two variations of the general methodology of the present invention are available.

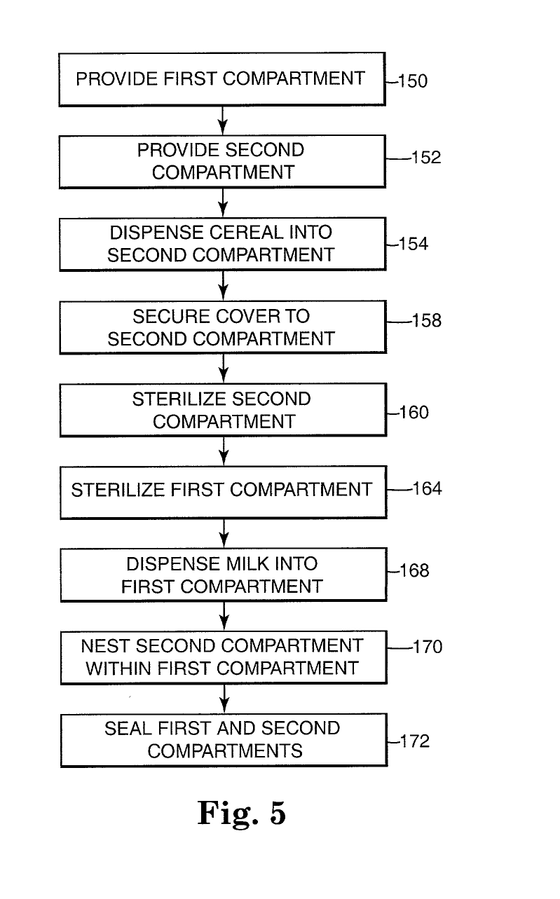

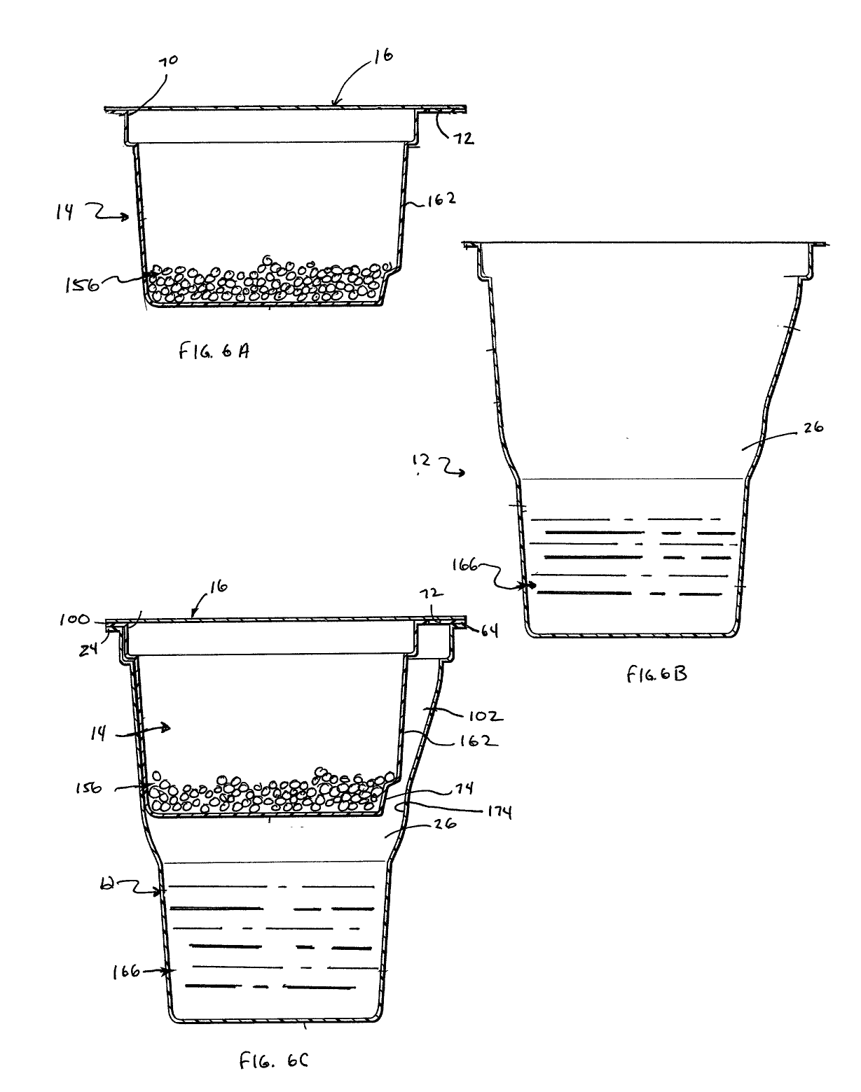

One variation is described by the flow diagram of FIG. 5. First, at step 150, the first compartment 12, as previously described, is provided. Similarly, at step 152, the second compartment 14, as previously described, is provided. With additional reference to FIG. 6A, at step 154 a quantity of a cereal product 156 (or other dry consumable product such as crackers, candy, pretzels, etc.) is dispensed into the second compartment 14. In one preferred embodiment, the second compartment 14 is sized to contain a single-serving of the cereal product 156, for example approximately ¾ cup. A most preferred embodiment of the cereal product 156 is described in U.S. patent application Ser. No. ______,entitled “Portable Container Separately Containing Two Consumable Products, And a Dry Consumable Product, Especially RTE Cereal, For Use Therewith” filed on even date herewith, the teachings of which are incorporated herein by reference. At step 158, the cover 16 is secured to the lip 64 such that the cover 16 encompasses and seals the pour opening 72 and the product opening 70. Notably, where the cover 16 includes the tear line 90 and/or the tab 92, the cover 16 is positioned relative to the lip 44 such that the tear line 90 and/or the tab 92 is aligned with the pour opening 72.

At step 160, an exterior surface 162 of the second compartment 14 is sanitized, preferably aseptically sterilized, according to accepted standards. Notably, because the cover 16 is sealed to the second compartment 14, the sanitizing agent will not contact or contaminate the cereal product 156. At step 164, the first compartment 12 is similarly sanitized.

With additional reference to FIG. 6B, a volume of milk 166 (or other liquid consumable product) is dispensed into the first compartment 12 at step 168. In one preferred embodiment, the first compartment 12 is sized to contain a single-serving of the milk 166, for example approximately 4 fluid ounces. Additionally, as made clear below, the internal storage region 26 of the first compartment 12 is sufficiently sized to contain the second compartment 14 as well as desired volume of the milk 166.

Once the milk 166 has been dispensed into the first compartment 12, the second compartment 14 is immediately nested within the first compartment 12 at step 170. This relationship is shown in FIG. 6C. In the nested position, the lip 64 of the second compartment 14 abuts the rim 24 of the first compartment 12 (e.g., the lip 64 rests on top of the rim 24). At step 172, the first and second compartments 12, 14 are sealed to one another, such as by the ultrasonic weld 100 between the lip 64 and the rim 24. Upon final assembly, then, the milk 166 is sealed within the first compartment 12 by the second compartment 14 and the cover 16. Further, the fluid passageway 102 is established between an interior surface 174 of the first compartment 12 and the exterior surface 162, and in particular the recess 74, of the second compartment 14. Once again, the fluid passageway 102 fluidly connects the pour opening 72 with the internal storage region 26 of the first compartment 12, and thus the milk 166 contained therein.

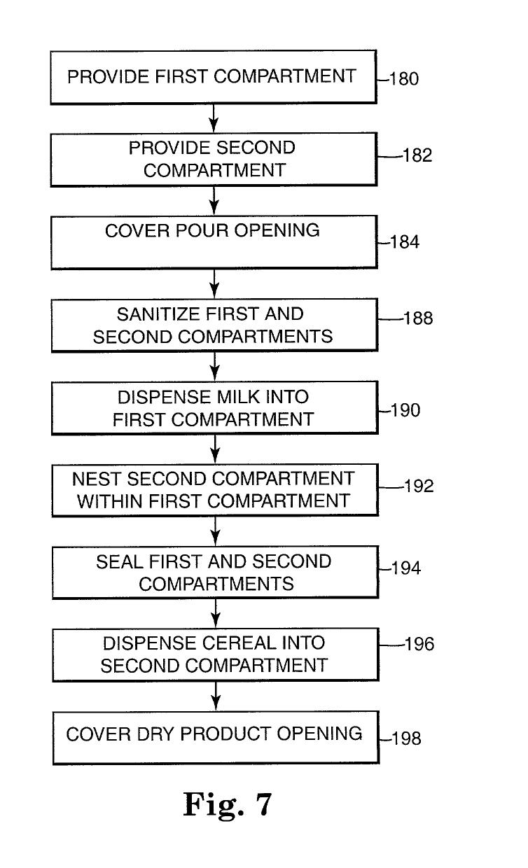

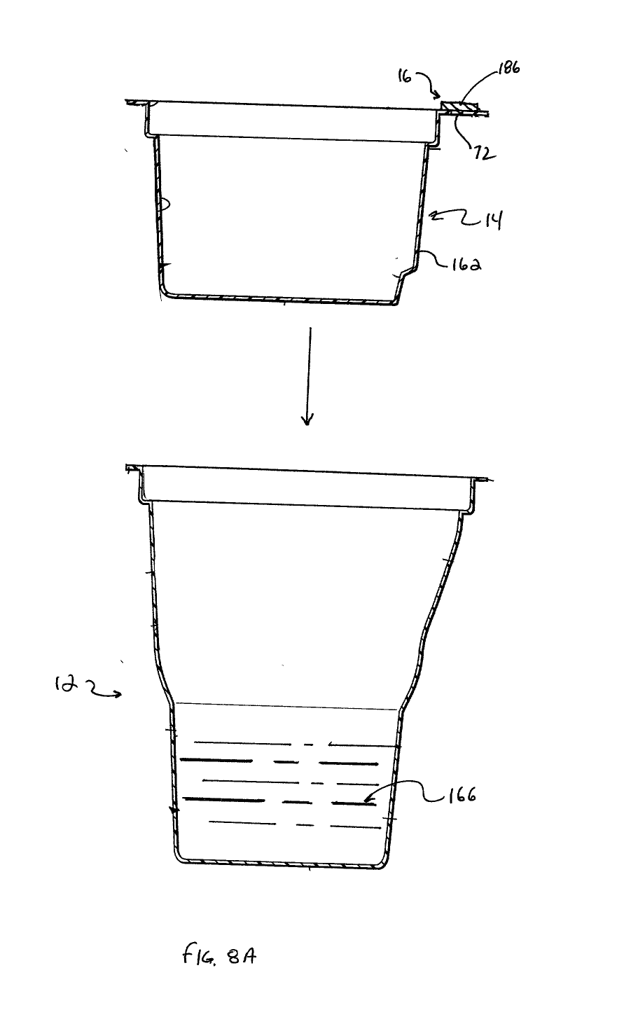

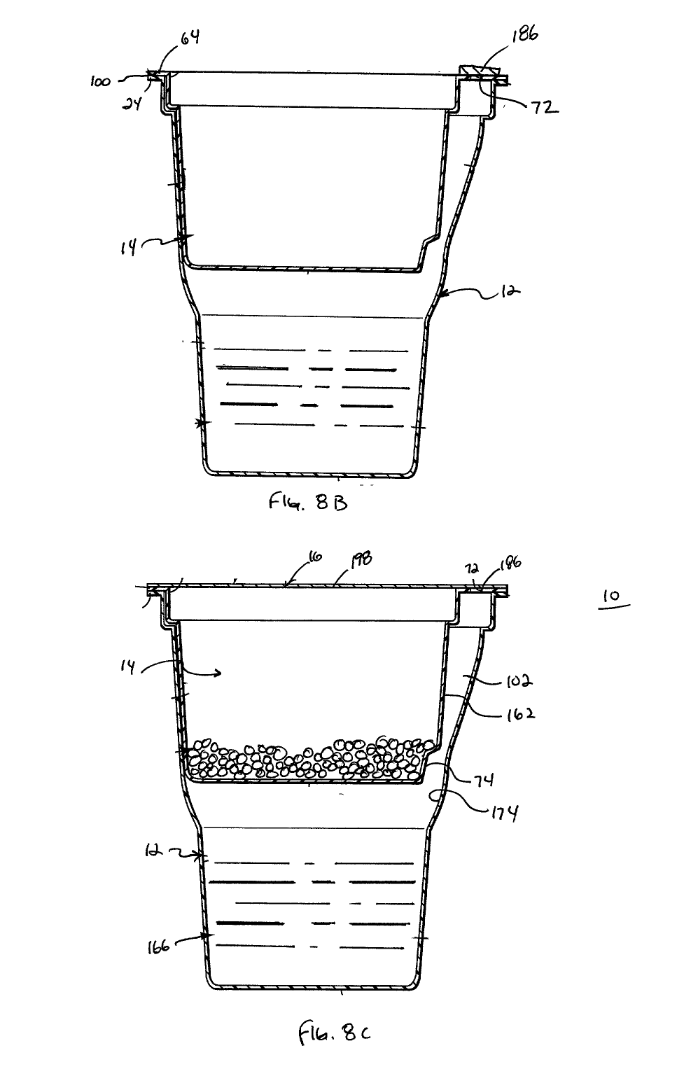

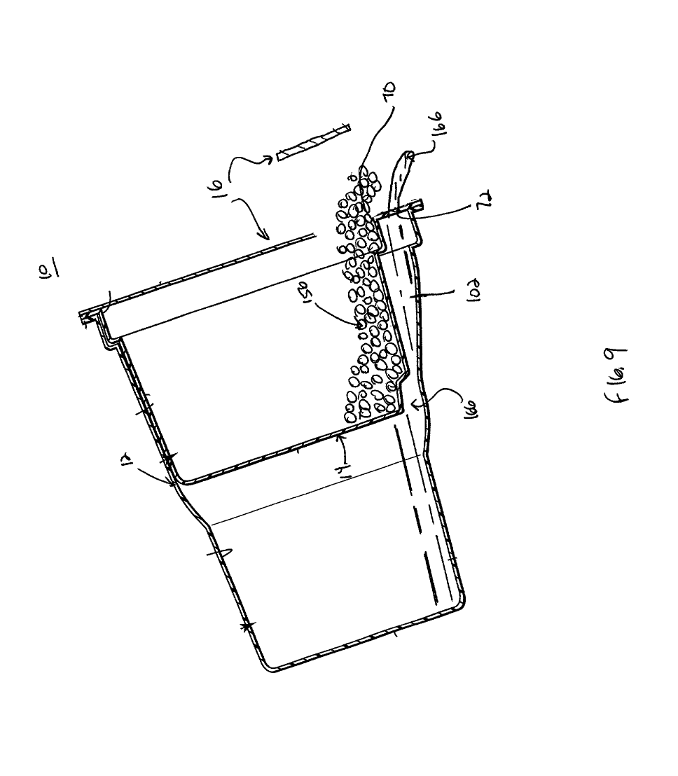

Another variation of the method of the present invention is described by the flow diagram of FIG. 7. First, at step 180, the first compartment 12, as previously described, is provided. Similarly, at step 182, the second compartment 14, as previously described, is provided. With additional reference to FIG. 8A, a portion of the cover 16 is secured to the lip 64, over the pour opening 72 at step 184. In particular, the cover 16 preferably associated with the method of FIG. 7 includes a first section 186 sized to encompass the pour opening 72. Once assembled, the first section 186 of the cover 16 seals the pour opening 72.

At step 188, the first and second compartments 12, 14 are sanitized, preferably aseptically sterilized, according to accepted standards. Preferably, only the exterior surface 162 of the second compartment 14 is sanitized. Regardless, at step 190, a volume of the milk 166 is dispensed into the first compartment 12.

Immediately after dispensing the milk 166, the second compartment 14 is nested within the first compartment 12 at step 192. This relationship is shown best in FIG. 8B. Once again, in the nested configuration, the lip 64 abuts or rests on top of the rim 24. The first and second compartments 12, 14 are then sealed to one another, such as by the ultrasonic weld 100, at step 194. The milk 166 is then sealed within the internal storage region 26 of the first compartment 12 via the second compartment 14 and the first section 186 otherwise sealed over the pour opening 72.

At step 196, a quantity of the cereal product 156 (or other dry consumable product) is dispensed into the second compartment 14 as shown in FIG. 8C. A second section 198 of the cover 16 is secured to the second compartment 14, encompassing the dry product opening 70. Once again, upon final assembly, the fluid passageway 102 is established between the exterior surface 162 of the second compartment 14 and the interior surface 174 of the first compartment 12.

Regardless of the specific method of manufacture, the container 10 is supplied to a consumer (not shown) with the cover 16 in tact. With reference to FIG. 9, during use, at least a portion of the cover 16 is removed from the second compartment 14. In the one preferred embodiment of FIG. 9, the cover 16 includes the tear line 90 that facilitates removal of the cover 16 from the pour opening 72, as well as a portion of the dry product opening 70. Alternatively, the cover 16 can be removed entirely.

Once the pour opening 72 and the dry product opening 70 have been exposed, the cereal 156 (or other dry consumable product) and the milk 166 (or other liquid consumable product) can be substantially simultaneously, preferably simultaneously, dispensed from the container 10. In this regard, the consumer (not shown) simply grasps the first compartment 12 with a single hand and directs the pour opening 72 towards his/her mouth (not shown). The container 10 is then tilted, causing the milk 166 to pass through the fluid passageway 102, and to be dispensed through the pour opening 70. Simultaneously, tilting of the container 10 causes the cereal 156 to dispense from the dry product opening 50. As shown in FIG. 9, the cereal 156 and the milk 166 are dispensed in close proximity to one another so that they are easily poured into the consumer's mouth. By controlling an orientation (or tilt) of the container 10, the consumer can easily dictate a desired flow rate of both the cereal 156 and the milk 166. In this regard, the pour opening 72 as well as the dry product opening 50 are easily centered within the consumer's mouth, such that the consumer can partially or entirely cover the pour opening 72 with his/her tongue (not shown), thereby providing further control over the flow rate of the milk 166. Finally, the first compartment 12 is preferably somewhat flexible, so that the consumer can slightly squeeze the first compartment 12, thereby providing a temporary increase in the flow rate of the milk 166. Between periods of consumption, the container 10 is sized for convenient storage within a “standard” compartment holder.

Following consumption, the container 10 is preferably recycled or otherwise disposed of. In this regard, the container 10 is configured as a single use device. Because the second compartment 14 is preferably permanently affixed (e.g., welded) to the first compartment 12, the second compartment 14 cannot easily be disassembled from the first compartment 12. Thus, the only access afforded to the internal storage region 26 of the first compartment 12 is via the pour opening 72. To this end, the pour opening 72 is relatively small, rendering cleaning of the first compartment 12 by a consumer (not shown) virtually impossible. Thus, the consumer will not be tempted to reuse the container 10 to store milk (or other liquid consumable product) within the first compartment 12, as the first compartment 12 cannot be cleaned. Also, the relatively small size of the pour opening 72 greatly impedes refilling of the first compartment 12, further discouraging reuse of the container 10. As a result, a configuration of the container 10 eliminates the improper sanitization risks otherwise associated with reusable designs.

The container of the present invention provides a marked improvement over previous designs. The cup-within-a-cup design separately contains both milk (or other liquid consumable product) and cereal (or other dry consumable product), and promotes simultaneous dispensing of the consumable products in close proximity to one another. Further, the method of manufacture of the container properly conforms with regulations relating to handling of milk in a highly cost-effective manner.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof. For example, the type of consumable product (dry or liquid) contained by the respective compartments can be reversed from that described above in the preferred embodiment, or both compartments can contain a dry consumable product or a liquid consumable product.

What is claimed is:

1. A portable, single-use container for separately containing two consumable products, the container comprising:
a first, outer compartment including:
a bottom,
a first compartment side wall extending from the bottom and defining a first compartment internal storage region,
an annular rim formed at a top of the first compartment side wall;
a second, inner compartment including:
a base,
a second compartment side wall extending from the base and defining a second compartment internal storage region,
an annular lip formed at a top of the second compartment side wall,
a pour opening formed through the lip, offset from the second compartment internal storage region; and
a cover secured to the lip;
wherein upon final assembly, the second compartment nests within the first compartment such that the lip abuts the rim and a fluid passageway is established between an interior surface of the first compartment side wall and an exterior surface of the second compartment side wall, the fluid passageway fluidly connecting the first compartment internal storage region and the pour opening.

2. The container of claim 1, wherein the first compartment is configured to contain a liquid consumable product and the second compartment is configured to contain a dry consumable product.

3. The container of claim 2, wherein the first consumable product is milk and the second consumable product is cereal.

4. The container of claim 1, wherein the lip rests on top of the rim.

5. The container of claim 1, wherein the lip is affixed to the rim.

6. The container of claim 1, wherein the first compartment internal storage region is completely sealed.

7. The container of claim 1, wherein an upper plane defined by the lip is substantially parallel with a lower plane defined by the bottom.

8. The container of claim 1, wherein a diameter of the bottom of the first compartment is approximately 2.2 inches.

9. The container of claim 1, wherein the annular lip has a minimum radial width of approximately 0.125 inch.

10. The container of claim 1, wherein the pour opening is elongated, having a major diameter of approximately 0.25 inch.

11. The container of claim 1, wherein the annular lip forms a radial extension having an increased radial width relative to a remainder of the lip, the pour opening being formed in the radial extension.

12. The container of claim 1, wherein the first compartment side wall forms a spout defining the fluid passageway.

13. The container of claim 1, wherein the first container side wall is formed of a flexible material such that the first container side wall can be squeezed to provide a temporary increased flow rate through the pour opening.

14. The container of claim 1, wherein the second compartment side wall forms a recess opposite the pour opening.

15. A packaged, good article comprising:
a portable, single-use container comprising:
a first, outer compartment including:
a bottom,
a first compartment side wall extending from the bottom and defining a first compartment internal storage region,
an annular rim formed at a top of the first compartment side wall,
a second, inner compartment including:
a base,
a second compartment side wall extending from the base and defining a second compartment internal storage region,
an annular lip formed at a top of the second compartment side wall,
a pour hole formed through the lip, offset from the second compartment internal storage region,
a cover secured to the lip;
a first consumable product sealed within the first compartment; and
a second consumable product contained within the second compartment;
wherein upon final assembly, the second compartment nests within the first compartment such that the lip abuts the rim and a fluid passageway is established between an interior surface of the first compartment side wall and an exterior surface of a second compartment side wall, the fluid passageway allowing passage of the milk from the first compartment internal storage region to the pour opening.

16. The packaged good article of claim 15, wherein the second consumable product is a dry consumable product.

17. The packaged good article of claim 16, wherein the dry consumable product is cereal.

18. The packaged good article of claim 15, wherein the first consumable product is a liquid consumable product.

19. The packaged good article of claim 18, wherein the liquid consumable product is milk.

20. A portable, single-use container for separately containing a two consumable products, the container comprising:
a first, outer compartment including:
a bottom,
a first compartment side wall extending from the bottom and defining a first compartment internal storage region,
an annular rim formed at a top of the first compartment side wall;
a second, inner compartment including:
a base,
a second compartment side wall extending from the base and defining a second compartment internal storage region,
an annular lip formed at a top of the second compartment side wall,
a pour opening formed through the lip, offset from the second compartment internal storage region; and
a cover secured to the lip;
wherein upon final assembly, the second compartment nests within the first compartment and the lip is affixed to the rim, and further wherein a fluid passageway is established between an interior surface of the first compartment side wall and an exterior surface of the second compartment side wall, the fluid passageway fluidly connecting the first compartment internal storage region and the pour opening.

21. The container of claim 22, wherein the lip is ultrasonically welded to the rim.

22. A portable, single-use container for separately containing two consumable products, the container comprising:
a first, outer compartment including:
a bottom,
a first compartment side wall extending from the bottom and defining a first compartment internal storage region,
an annular rim formed at a top of the first compartment side wall;
a second, inner compartment including:
a base,
a second compartment side wall extending from the base and defining a second compartment internal storage region,
an annular lip formed at a top of the second compartment side wall,
a pour opening formed through the lip, offset from the second compartment internal storage region; and
a cover secured to the lip;
wherein upon final assembly, the second compartment nests within the first compartment and the first compartment internal storage region is sealed, and further wherein a fluid passageway is established between an interior surface of the first compartment side wall and an exterior surface of the second compartment side wall, the fluid passageway fluidly connecting the first compartment internal storage region and the pour opening.

23. The container of claim 22, wherein the cover is sealed to the lip, encompassing the pour opening, and further wherein the lip is sealed to the rim.

24. A portable, single-use container for separately containing two consumable products, the container comprising:
a first, outer compartment including:
a bottom,
a first compartment side wall extending from the bottom and defining a first compartment internal storage region,
an annular rim formed at a top of the first compartment side wall;
a second, inner compartment including:
a base,
a second compartment side wall extending from the base and defining a second compartment internal storage region,
an annular lip formed at a top of the second compartment side wall,
a pour opening formed through the lip, offset from the second compartment internal storage region; and
a cover secured to the lip;
wherein upon final assembly, the second compartment nests within the first compartment and the lip is affixed to the rim, and further wherein lip abuts the rim and a fluid passageway is established between an interior surface of the first compartment side wall and an exterior surface of the second compartment side wall, the fluid passageway fluidly connecting the first compartment internal storage region and the pour opening, and further wherein an upper plane defined by the lip is substantially parallel with a lower plane defined by the bottom.

25. A method of manufacturing a portable, single-use container separately containing two consumable products, the method comprising:
providing a first, outer compartment including a bottom, a first compartment side wall and an annular rim;
providing a second, inner compartment including a base, a second compartment side wall and an annular lip, the lip forming a pour opening;
dispensing a first liquid consumable product into the first compartment;
dispensing a quantity of a second consumable product into the second compartment;
placing the second compartment into the first compartment such that lip abuts the rim; and
sealing the lip to the rim;
wherein a fluid passageway is established between an exterior surface of the second compartment side wall and an interior surface of the first compartment side wall for allowing passage of the first consumable product from the first compartment to the pour opening.

26. The method of claim 25, further comprising the steps of:
a) covering the second compartment, including the pour opening, after dispensing the second consumable product;
b) sanitizing an exterior of the second compartment;
c) sanitizing the first compartment; and
d) dispensing the first consumable product into the first compartment and placing the second compartment into the first compartment after sanitizing the first compartment;
wherein upon final assembly, the first consumable product is contained within a sanitized environment.

27. The method of claim 25, further comprising the steps of:
a) sanitizing the first compartment;
b) sanitizing the second compartment;
c) dispensing the first consumable product into the first compartment;
d) sealing the pour opening before placing the second compartment into the first compartment; and
e) dispensing the second consumable product into the second compartment after placing the second compartment into the first compartment and sealing the lip to the rim;
wherein upon final assembly, the first consumable product is contained within a sanitized environment.

28. The method of claim 25, wherein dispensing a first consumable product includes dispensing a liquid consumable product into the first compartment.

29. The method of claim 28, wherein the liquid consumable product is milk.

30. The method of claim 25, wherein dispensing a second consumable product includes dispensing a dry consumable product.

31. The method of claim 30, wherein the dry consumable product is cereal.

32. The method of claim 25, wherein securing the lip to the rim includes ultrasonically welding the lip to the rim.

33. The method of claim 25, further comprising:
providing a cover; and
sealing the cover to the second compartment lip, the cover being configured such that with at least partial removal of the cover from the second compartment, the pour opening and at least a portion of the second compartment are exposed to allow dispensing of the first and second consumable products, respectively.

34. A method for dispensing a two consumable products from a portable, single-use container, the method comprising:
providing a container including a first, outer compartment containing a first consumable product, a second, inner compartment containing a second consumable product, and a cover covering the second compartment, wherein the second compartment includes an annular lip forming a pour opening and is nested within the first compartment such that the lip abuts and is secured to an annular rim of the first compartment and a fluid passageway to the pour opening is established between an interior surface of the first compartment and an exterior surface of the second compartment;
removing at least a portion of the cover to expose the pour opening and at least a portion of the second compartment;
grasping the container; and
substantially simultaneously dispensing a portion of the first consumable product from the pour opening and a portion of the second consumable product from the second compartment.

35. The method of claim 34, wherein grasping the container includes grasping the container with a single hand.

36. The method of claim 34, further comprising:
placing the container into a cup holder after dispensing at least a portion of the first consumable product and the second consumable product.

37. The method of claim 34, wherein the first consumable product is a liquid consumable product and the second consumable product is a dry consumable product.

38. The method of claim 37, wherein the dry consumable product is a cereal and the liquid consumable product is milk.
